(19) United States
(12) Patent Application Publication
(10) Pub. No.: US 2026/0237309 A1
(43) Pub. Date: Aug. 13, 2026

(54) SYSTEMS AND METHODS FOR VALIDATING REAL-TIME CONTROL OF AUTONOMOUS VEHICLES

(71) Applicant: THE BOEING COMPANY, Arlington, VA (US)

(72) Inventors: Brendan Matthew Howley, St. Charles, MO (US); Eric George Muehle, Henderson, NV (US); Lance Spinnie, St. Peters, MO (US); Caleb G. Price, Shiloh, IL (US); Ryan P. McClintock, Brentwood, MO (US); Thomas A. Harrison, St. Louis, MO (US); Ephraim J. Chen, Arlington, VA (US)

(21) Appl. No.: 19/048,599

(22) Filed: Feb. 7, 2025

(51) Int. Cl. G08G 5/80; G08G 5/30

(52) U.S. Cl. CPC G08G 5/80; G08G 5/30

(57) ABSTRACT

A device includes a first interface, a second interface, and one or more processors configured to: obtain, via the first interface, a command from an automation system and evaluate the command to generate a determination of whether the command complies with a plurality of validation criteria; when the determination indicates that the command complies with the plurality of validation criteria, generate data associated with the command, the data operable to cause a vehicle management system to generate vehicle control signals based on the command and communicate the data to the vehicle management system via the second interface; and when the determination indicates that the command does not comply with at least one validation criteria of the plurality of validation criteria, generate data associated with a failure to comply with the at least one validation criteria and communicate the data to the automation system via the first interface.

### GOVERNMENT SUPPORT CLAUSE

The invention was made with government support under FA8002-22-F-6001 awarded by the Department of Defense. The Government has certain rights in the invention.

### FIELD OF THE DISCLOSURE

The present disclosure is generally related to systems and methods for validating real-time control of autonomous vehicles.

### BACKGROUND

With the increasing importance of autonomous air vehicles, safe and efficient operation of those vehicles in complex environments becomes correspondingly important. For certain autonomous air vehicles, the integration of autonomous mission control software with flight critical systems can introduce complications including, but not limited to, susceptibility to non-deterministic behavior and complications of arbitrating control between autonomous flight command systems (i.e., systems that provide flight commands without human intervention) and remote operation control systems (i.e., systems that provide flight commands originating with a human operator).

Introduction of machine learning (ML) applications, where the complexity of the autonomy is not well understood, introduces additional complexity, including unexpected safety hazards. For example, holes and gaps in the training data for ML applications can give rise to undefined decisions from an ML-based autonomy, when the vehicle is faced with situations trained with insufficient or inaccurate training data. As the complexity of autonomy increases, the need for an independent monitor for the decisions that these systems make, relative to the safety of the vehicle platform, will correspondingly increase.

Certain existing approaches to autonomous system integration include contingency measures in the flight control system to prevent erroneous commands from lower-criticality control software. However, this approach can force all isolation and control arbitration into one monolithic flight control subsystem, coupling that functionality with generic guidance, navigation, and control code. This integration can make system modifications costly. It can also prevent integration of third party applications, making those applications unavailable to an autonomous vehicle.

### SUMMARY

In a particular implementation, a device includes a first interface configured to couple to an automation system of a vehicle. The device also includes a second interface configured to couple to a vehicle management system of the vehicle. The device also includes one or more processors. The one or more processors are configured to obtain, via the first interface, a command from the automation system and evaluate the command to generate a determination of whether the command complies with a plurality of validation criteria. The one or more processors are also configured to, when the determination indicates that the command complies with the plurality of validation criteria, generate data associated with the command (where the data is operable to cause the vehicle management system to generate vehicle control signals based on the command); and communicate the data to the vehicle management system via the second interface. The one or more processors are also configured to, when the determination indicates that the command does not comply with at least one validation criteria of the plurality of validation criteria, generate data associated with a failure to comply with the at least one validation criteria; and communicate the data to the automation system via the first interface.

In another particular implementation, a vehicle includes an automation system, a vehicle management system, and a device. The device includes a first interface configured to couple to the automation system and a second interface configured to couple to the vehicle management system. The device also includes one or more processors. The one or more processors are configured to obtain, via the first interface, a command from the automation system and evaluate the command to generate a determination of whether the command complies with a plurality of validation criteria. The one or more processors are also configured to, when the determination indicates that the command complies with the plurality of validation criteria, generate data associated with the command (where the data is operable to cause the vehicle management system to generate vehicle control signals based on the command); and communicate the data to the vehicle management system via the second interface. The one or more processors are also configured to, when the determination indicates that the command does not comply with at least one validation criteria of the plurality of validation criteria, generate data associated with a failure to comply with the at least one validation criteria; and communicate the data to the automation system via the first interface.

In another particular implementation, a method includes obtaining, via a first interface of a device, a command from an automation system. The method also includes evaluating the command to generate a determination of whether the command complies with a plurality of validation criteria. The method also includes, when the determination indicates that the command complies with the plurality of validation criteria, generating data associated with the command (where the data is operable to cause a vehicle management system to generate vehicle control signals based on the command); and communicating the data to the vehicle management system via a second interface of the device. The method also includes, when the determination indicates that the command does not comply with at least one validation criteria of the plurality of validation criteria, generating data associated with a failure to comply with the at least one validation criteria; and communicating the data to the automation system via the first interface.

In another particular implementation, a non-transitory computer-readable medium includes instructions that, when executed by one or more processors, cause the one or more processors to obtain, via a first interface of a device, a command from an automation system. The instructions, when executed by the one or more processors, also cause the one or more processors to evaluate the command to generate a determination of whether the command complies with a plurality of validation criteria. The instructions, when executed by the one or more processors, also cause the one or more processors to, when the determination indicates that the command complies with the plurality of validation criteria, generate data associated with the command (where the data is operable to cause a vehicle management system to generate vehicle control signals based on the command); and communicate the data to the vehicle management system via a second interface of the device. The instructions, when executed by the one or more processors, also cause the one or more processors to, when the determination indicates that the command does not comply with at least one validation criteria of the plurality of validation criteria, generate data associated with a failure to comply with the at least one validation criteria; and communicate the data to the automation system via the first interface.

In another particular implementation, a method includes obtaining, via a first interface of a device, a command from an automation system. The method also includes evaluating the command to generate a determination of whether the command complies with a plurality of validation criteria. The method also includes, when the determination indicates that the command complies with the plurality of validation criteria, generating data associated with the command (where the data is operable to cause a vehicle management system to generate vehicle control signals based on the command); and communicating the data to the vehicle management system via a second interface of the device. The method also includes, when the determination indicates that the command does not comply with at least one validation criteria of the plurality of validation criteria, generating data associated with a failure to comply with the at least one validation criteria; and communicating the data to the automation system via the first interface. The method also includes executing one or more of the vehicle control signals by the vehicle management system.

### BRIEF DESCRIPTION OF THE DRAWINGS

FIG. 1 depicts an example of a system for validating real-time control of autonomous vehicles, according to one or more examples of the subject disclosure.

FIG. 2 illustrates an example architecture for implementing the system of FIG. 1, according to some examples of the subject disclosure.

FIG. 3 is a flowchart that illustrates an example of a method for validating real-time control of autonomous vehicles, in accordance with some examples of the subject disclosure.

FIG. 4 is a flowchart illustrative of an example of a life cycle of an aircraft that includes a computing device configured to validate real-time control of autonomous vehicles, in accordance with some examples of the subject disclosure.

FIG. 5 is a block diagram of a particular implementation of the aircraft associated with the life cycle of FIG. 4.

FIG. 6 is a block diagram of a computing environment including a computing device configured to support aspects of computer-implemented methods and computer-executable program instructions (or code) according to the present disclosure.

### DETAILED DESCRIPTION

The systems and methods disclosed herein enable validation of real-time control of autonomous vehicles at least by validating routes and steering vectors to ensure safe operation and avoid collisions with terrain, and by arbitrating and publishing validated vehicle commands to a vehicle control system. In some configurations, the systems and methods disclosed herein can be implemented as a platform isolator with dual redundant embedded computers, a real-time operating system, and software modules executing the operations and methods described in more detail below. The implementation of multiple redundant systems allows for increased safety in flight operations. Certain operational standards, such as Military Standard 882, for example, requires multiple redundant systems.

A particular implementation of the platform isolator includes two or more isolated data buses, which could be physically partitioned within an embedded computer. Unverified vehicle commands from autonomous control software or command and control radio terminals enter the platform isolator on a low-assurance data bus. Before being published to a high-assurance data bus, the unverified vehicle commands pass through command validation software via a dedicated and isolated interface. Command validation software ensures a given command would not result in a hazard or failure of any kind for the autonomous vehicle. The systems and methods disclosed herein are agnostic to the particular type of autonomous vehicle. Particular implementations can vary depending on the autonomous vehicle type. For example, generally command validation software inputs could include a vehicle navigation solution. For an autonomous aircraft, validation software inputs could also include Automatic Dependent Surveillance-Broadcast (ADSB) data, rulesets, and flight plans.

In a particular configuration, the low-and high-assurance data buses can be agnostic to protocol and physical implementation. The data buses correspond to physically partitioned shared mediums for software module communication. Communications from low-to high-assurance buses pass command validation, while high-to low-assurance communications are one way.

Validation could include, for example, identifying a lack or presence of problematic terrain or an obstacle in the commanded flight path, ensuring the commanded vehicle route does not violate a vehicle's mission objectives, etc. For an autonomous aircraft, validation could also include, for example, ensuring a command would not exceed a flight envelope threshold, identifying a lack or presence of ADSB Traffic in the commanded flight path, ensuring the commanded flight path would not violate the flight plan, etc. Once a command is validated, the command can be published to control management software, which is responsible for arbitrating between vehicle command control sources. Determination of control could include, for example, arbitrating mechanisms for transfer of control between a remote operator and autonomous vehicle command systems.

A technical advantage of the subject disclosure includes implementing logic for control arbitration and validation to a vehicle management system. For example, control management software can take inputs from a plurality of validation criteria and real-time-collision data, and determine that, even though a validated route exists, a proposed route based on the real-time collision avoidance data offers a decreased risk of collision, and thus it is preferable to send the proposed route to the vehicle management system. In other examples, control arbitration and validation can be based on other data and/or components, such as real-time evasive maneuver data. The systems and methods disclosed herein can include a list of components and/or data that can be considered in determining control arbitration. The components and/or data can be ranked, for example, in a hierarchical order, allowing for a single winner arbitration scheme.

Another technical advantage of the subject disclosure includes providing increased safety and/or efficient operation for autonomous vehicles by validating vehicle control commands according to a variety of criteria, including those selected for collision avoidance, fuel requirements, route selection, or a combination thereof.

Another technical advantage of the subject disclosure includes enabling the implementation of third-party autonomous vehicle control systems into an autonomous vehicle control system. By isolating command communication to a vehicle management system and validating commands prior to that communication, the systems and methods disclosed herein can present a particular autonomous vehicle's vehicle management system in a manner that is agnostic as to the particular control system originating those commands.

Another technical advantage of the subject disclosure includes enabling the efficient operation of autonomous vehicles by limiting the amount of data required for a particular route determination when validating a particular command, determining a route for the autonomous vehicle, etc.

Another technical advantage of the subject disclosure includes enabling real-time collision avoidance. The systems and methods disclosed herein can generate potential air tracks in close proximity to the aircraft from ADSB or sensor (e.g., optical, laser detection and ranging, etc.) data and can execute avoidance maneuvers. Remote or autonomy issued commands can be temporarily voided during an avoidance maneuver.

Another technical advantage of the subject disclosure includes validation of commands related to vehicle load management. For example, the systems and methods disclosed herein can enable validation of commands related to cargo management (inventory, release, loading, etc.), military stores management (armament, fuel, reconnaissance, targeting, etc.), other vehicle cargo management, or a combination thereof.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, a system may be described herein as including one or more computing devices (“computing device(s)”), which indicates that in some implementations the system includes a single computing device and in other implementations the system includes multiple computing devices. For ease of reference herein, such features are generally introduced as “one or more” features and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

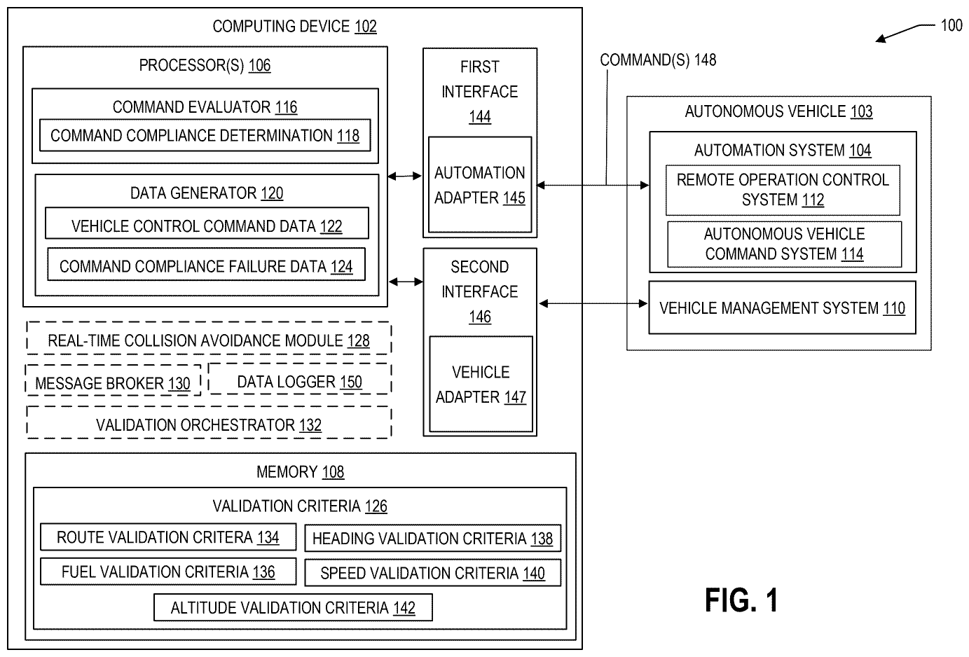

FIG. 1 depicts an example of a system 100 for validating real-time control of autonomous vehicles, according to one or more examples of the subject disclosure. The system 100 includes a computing device 102 coupled to one or more autonomous vehicles 103. The autonomous vehicle 103 can be, for example, an autonomous aircraft, car, truck, boat, spacecraft, etc.

Each autonomous vehicle 103 can include an automation system 104 and a vehicle management system 110. The automation system 104 can include one or more components configured to provide commands for the autonomous vehicle 103 to complete one or more portions of a predetermined mission for the autonomous vehicle 103. For example, the automation system 104 can include a remote operation control system 112 configured to enable remote operation of the autonomous vehicle 103 by a remote operator. As another example, the automation system 104 can include an autonomous vehicle command system 114 configured to enable the autonomous vehicle 103 to determine one or more commands for the autonomous vehicle 103 without further input from a remote operator.

The vehicle management system 110 can include one or more components configured to execute the commands of the automation system 104 at the autonomous vehicle 103. For example, the vehicle management system 110 can include circuitry configured to adjust one or more motors, rotors, etcetera in order for the autonomous vehicle 103 to carry out one or more commands from the automation system 104.

In some implementations, the computing device 102 includes a first interface 144 configured to couple the computing device 102 to the automation system 104 of the autonomous vehicle 103. The computing device 102 also includes a second interface 146 configured to couple the computing device 102 to the vehicle management system 110 of the autonomous vehicle 103. The computing device 102 also includes one or more processors 106 coupled to the first interface 144, the second interface 146, and a memory 108.

In some aspects, the first interface 144 can include a bus interface that includes circuitry configured to receive data from the automation system 104 and communicate that data to the computing device 102. For example, the first interface 144 can include the low-assurance data bus described above. The second interface 146 can include a bus interface that includes circuitry configured to receive data from the computing device 102 and communicate that data to the vehicle management system 110. For example, the second interface 146 can include the high-assurance data bus described above.

The one or more processors 106 are configured to obtain, via the first interface 144, one or more commands 148 from the automation system 104. For example, a command 148 from the automation system 104 for the autonomous vehicle 103 to execute a particular maneuver (e.g., turn a particular direction, go to a particular height or speed, etc.) is first passed to the computing device 102 for verification. In some aspects, the first interface 144 can include an automation adapter 145 configured to translate one or more commands 148 from a first format to a second format. The automation adapter 145 can be implemented as a software module, circuitry configured to translate one or more commands 148 from a first format to a second format, or a combination thereof. For example, the automation adapter 145 can include a software module including instructions executable by the processor(s) 106 to translate command(s) 148 from a format native to the automation system 104 of the autonomous vehicle 103 to a format native to the computing device 102.

In some implementations, the processor(s) 106 can include a command evaluator 116 configured to evaluate the command(s) 148 to generate a command compliance determination 118. The command compliance determination 118 can include, for example, a determination of whether the command(s) 148 comply with a plurality of validation criteria 126 stored at the memory 108.

The validation criteria 126 can include data associated with one or more validation types for the command(s) 148. For example, the validation criteria can include, among others, route validation criteria 134, fuel validation criteria 136, heading validation criteria 138, speed validation criteria 140, altitude validation criteria 142, or a combination thereof. Route validation criteria 134 can include, for example, validation criteria related to terrain along a proposed route, obstacles along a proposed route, etc. Fuel validation criteria 136 can include, for example, validation criteria related to an amount of fuel currently available to the autonomous vehicle 103, refueling options available, fuel required to complete a mission, etc. Heading validation criteria 138 can include, for example, validation criteria related to a heading for the autonomous vehicle 103 as it relates to the command 148, a heading required to complete a mission, etc. Speed validation criteria 140 can include, for example, validation criteria related to a speed for the autonomous vehicle 103 as it relates to the command 148, a speed required to complete a mission, etc. Altitude validation criteria 142 can include, for example, validation criteria related to an altitude for the autonomous vehicle 103 as it related to the command 148, an altitude required to complete a mission, etc. The validation criteria 126 can include one or more of the above examples, other validation criteria 126 appropriate for use in determining that the command 148 is appropriate for a particular mission, or a combination thereof.

In some implementations, the processor(s) 106 can also include a data generator 120. The data generator 120 can be configured to, when the command compliance determination 118 indicates that the command 148 complies with the plurality of validation criteria 126, generate vehicle control command data 122. The vehicle control command data 122 can include data associated with the command 148, the data operable to cause the vehicle management system 110 to generate vehicle control signals based on the command 148. For example, when the command evaluator 116 determines that the command 148 complies with the plurality of validation criteria 126, the data generator 120 can be configured to generate the vehicle control command data 122 that can cause the vehicle management system 110 to generate vehicle control signals appropriate to execute the command 148.

The data generator 120 can also be configured to, when the command compliance determination 118 indicates that the command 148 does not comply with at least one of the validation criteria of the plurality of validation criteria 126, generate command compliance failure data 124. The command compliance failure data 124 can include data associated with a failure to comply with the at least one validation criteria of the plurality of validation criteria 126.

In some implementations, the processor(s) 106 can also be configured to communicate data to the autonomous vehicle 103. The data can include different data for different portions of the autonomous vehicle 103, depending on the command compliance determination 118. For example, when the command compliance determination 118 indicates that the command 148 complies with the plurality of validation criteria 126, the processor(s) 106 can be configured to communicate the control command data 122 to the vehicle management system 110 via the second interface 146. When the command compliance determination 118 indicates that the command 148 does not comply with at least one validation criteria of the plurality of validation criteria 126, the processor(s) 106 can be configured to communicate the command compliance failure data 124 to the automation system 104 via the first interface 144.

In some aspects, the second interface 146 can include a vehicle adapter 147 configured to translate some or all of the vehicle control command data 122, some or all of the command compliance failure data 124, or a combination thereof from the second format to a third format. The vehicle adapter 147 can be implemented as a software module, circuitry configured to translate data from the second format to a third format, or a combination thereof. For example, the vehicle adapter 147 can include a software module including instructions executable by the processor(s) 106 to translate the vehicle control command data 122 and/or the command compliance failure data 124 from the format native to the computing device 102 to a format native to the vehicle management system 110.

In operation, the computing device 102 can be configured to validate the command 148 received from the automation system 104 of the autonomous vehicle 103 before passing the command 148 to the vehicle management system 110 of the autonomous vehicle 103. For example, if the remote operation control system 112 issues a particular command 148 that an autonomous aircraft should alter its current flight path to a different heading, the computing device 102 can be configured to obtain the command 148 via the first interface 144 and evaluate the command 148 to generate the command compliance determination 118, indicating whether the command 148 complies with the plurality of validation criteria 126. The evaluation can include validating the command to the different heading according to one or more of the heading validation criteria 138 (e.g., is this new heading allowed under current operational constraints), route validation criteria 134 (e.g., will this new heading place the autonomous vehicle 103 in a position to strike an obstacle along the route), fuel validation criteria 136 (e.g., does the autonomous aircraft have sufficient available fuel to complete the assigned mission via the new heading), etc. If the command 148 complies with the plurality of validation criteria 126, the data generator 120 can generate the vehicle control command data 122 for communication to the vehicle management system 110 via the second interface 146 so that the vehicle management system 110 can execute the command 148 (e.g., causing the autonomous aircraft to change position to accomplish the new heading). If the command 148 does not comply with the plurality of validation criteria 126, the data generator 120 can generate the command compliance failure data 124 for communication to the automation system 104 via the first interface 144. The command compliance failure data 124 may indicate, for example, the specific validation criteria that the command 148 failed, reasons for the failure, etc. In a particular aspect, the command compliance failure data 124 can include data sufficient to enable the automation system 104 (and/or an operator thereof) to understand the reason(s) for rejecting the command 148.

Although certain components are illustrated in a particular configuration in the example system 100, more, fewer, and/or different components in a different configuration are possible without departing from the scope of the subject disclosure. For example, the computing device 102 can also include a real-time collision avoidance module 128 coupled to the processor(s) 106, a message broker 130 coupled to the processor(s) 106, a validation orchestrator coupled to the processor(s) 106, or some combination thereof.

The real-time collision avoidance module 128 can include circuitry that enables the computing device 102 to evaluate the incoming command 148 to determine whether the command 148 indicates an increased likelihood of a collision of the autonomous vehicle 103 with another object (e.g., a route obstacle, another vehicle, etc.).

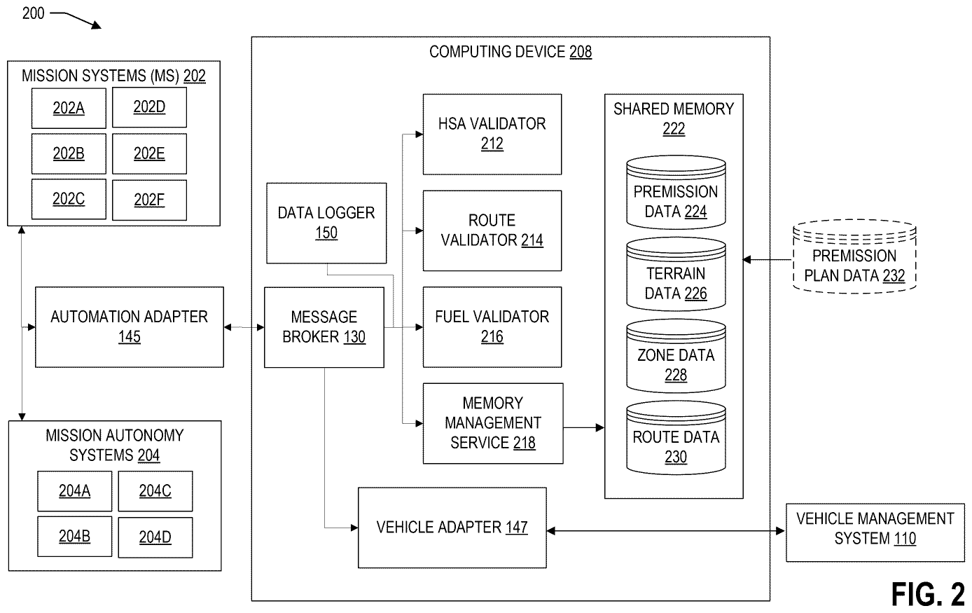

The message broker 130 can include circuitry configured to route messages among various components of the computing device 102, as described in more detail below with reference to FIG. 2. The validation orchestrator 132 can include circuitry configured to select a first validation criterion and a second validation criterion from among the plurality of validation criteria 126. In some aspects, not all validation criteria 126 will be appropriate for a particular operation of the autonomous vehicle 103. For example, the validation orchestrator 132 can be configured to select the first and second validation criteria based at least on a route determination for the autonomous vehicle. The route determination can include data associated with one or more portions of a proposed route for the autonomous vehicle. In a particular configuration, the route determination can be based on one or more of a no-fly zone determination, a route terrain determination, a route obstacle determination, or a collision avoidance determination. The no-fly zone determination can include data that indicates that a portion of the proposed route would take the autonomous vehicle 103 through a no-fly zone. The route terrain determination can include data that indicates that a portion of the proposed route would bring the autonomous vehicle 103 into conflict with unacceptable terrain. The route obstacle determination can include data that indicates that a portion of the proposed route would bring the autonomous vehicle 103 into conflict with an obstacle. The collision avoidance determination can include data that indicates that a portion of the proposed route would bring the autonomous vehicle 103 into conflict with another object or vehicle.

In some aspects, the validation orchestrator 132 can be configured to select the first and second validation criteria based at least on a collision avoidance determination for the vehicle. The collision avoidance can be generated, for example, as part of the route determination described above. The collision avoidance can also be generated, for example, by the real-time collision avoidance module 128 distinct from the route determination. The collision avoidance can be based, for example, on Automatic Dependent Surveillance—Broadcast (ADSB) data. The ADSB data can be received from other vehicles, from a ground-based air control station, other appropriate traffic monitoring systems, or a combination thereof.

In some aspects, the validation orchestrator 132 can be configured to select the first and second validation criteria based on a load management determination for the vehicle. The load management determination can be generated, for example, as part of the route determination described above or distinct from the route determination. The load management determination can be based, for example, on stores management system data. The stores management system data can indicate, for example, weapons, fuel, avionics, etc. related to a particular flight mission. The load management determination can also be based, for example, on cargo management data indicative of cargo type, cargo delivery parameters, etc. for a particular cargo load for the autonomous vehicle 103.

In a particular aspect, the load management determination can be based on a rules of engagement determination, a mission objective determination, or other determination related to pre-mission data that specifies safety and/or efficacy characteristics of load delivery for a particular mission. For example, a mission for an autonomous aircraft can include weapons management. The rules of engagement determination can be based, for example, on rules of engagement data indicative of when, where, and how a particular mission is to be carried out. The mission objective determination can be based, for example, on mission objective data indicative of one or more objectives associated with a particular mission.

In some aspects, the validation orchestrator 132 can also be configured to select the first and second validation criteria based at least on a heading determination for the autonomous vehicle 103. The heading determination can be generated, for example, as part of the route determination described above. The heading determination can also be generated, for example, by the processor(s) 106 distinct from the route determination. In a particular aspect, the heading determination can be based at least on one or more of a heading terrain determination, a heading obstacle determination, or the collision avoidance determination described above.

In some aspects, the computing device 102 can also include a data logger 150 coupled to the one or more processors (106). The data logger 150 can include circuitry configured to record a plurality of validation determinations made by the one or more processors 106 during a mission associated with the autonomous vehicle 103. For example, the data logger 150 can be configured to record the command compliance determination 118 made by the command evaluator 116 for each command 148 communicated to the computing device 102 from the automation system 104 as part of a particular mission for the autonomous vehicle 103.

The system 100 described above enables increased safe and/or efficient operation of the autonomous vehicle 103 by validating the command(s) 148 according to the plurality of validation criteria 126. For example, the processor(s) 106 can be configured to validate the command 148 from the automation system 104 (whether from the remote operation control system 112 or the autonomous vehicle command system 114) according to the route validation criteria 134, the heading validation criteria 138, the fuel validation criteria 136, the speed validation criteria 140, the altitude validation criteria 142, or a combination thereof.

The system 100 also enables the implementation of third-party autonomous vehicle control systems alongside the vehicle management system 110 for the autonomous vehicle 103. By isolating command communication to and from the vehicle management system 110 and validating the command(s) 148 prior to that communication, the system 100 can present the vehicle management system 110 in a manner that is agnostic as to the particular automation system 104 originating those command(s) 148.

FIG. 2 illustrates an example architecture 200 for implementing the system 100 of FIG. 1, according to some examples of the subject disclosure. The example architecture 200 includes a plurality of mission systems 202 and a plurality of mission autonomy systems 204 coupled to a computing device 208 via an automation adapter 145. The mission systems 202 can include one or more remote operation control systems (e.g., the remote operation control system 112 of FIG. 1). The mission autonomy systems 204 can include one or more autonomous vehicle command systems (e.g., the autonomous vehicle command system 114 of FIG. 1). The computing device 208 generally corresponds to the computing device 102 of FIG. 1.

In some implementations, the mission systems 202 and the mission autonomy systems 204 can be configured to communicate with the automation adapter 145 via a data bus. For example, the data bus can include an Open Mission Systems (OMS) standard service bus. The automation adapter 145 can include circuitry configured to receive one or more commands from one or more mission systems 202 and/or one or more mission autonomy systems 204 and communicate those command(s) to the computing device 208. The automation adapter 145 can include one or more components configured to translate messages from one format to another. For example, the automation adapter 145 could include a software module configured to translate messages from a first format understandable by the mission systems 202 and/or the mission autonomy systems 204 to a second format understandable by the computing device 208.

In some implementations, the computing device 208 can include the message broker 130 of FIG. 1 configured to receive the communication from the automation adapter 145. The message broker 130 can be configured to route some or all of a messages received from the automation adapter 145 to one or more validator services. For example, the message broker 130 can route a heading, speed, and altitude (HSA) command to an HSA validator 212. The HSA validator 212 can be configured to validate the incoming HSA command according to one or more HSA-related validation criteria (e.g., the validation criteria 126 of FIG. 1). This can include, for example, altitude validation criteria 142, speed validation criteria 140, etc.

The message broker 130 can also be configured to transmit a route-related command to a route validator 214. The route validator 214 can be configured to validate the incoming route command according to one or more route-related validation criteria (e.g., the validation criteria 126 of FIG. 1). This can include, for example, route validation criteria 134, heading validation criteria 138, fuel validation criteria 136, etc. The message broker 130 can also be configured to communicate a fuel-related command to a fuel validator 216. The fuel validator 216 can be configured to validate the incoming fuel command according to one or more fuel-related validation criteria (e.g., the validation criteria 126 of FIG. 1). This can include, for example, fuel validation criteria 136.

In some implementations, the computing device 208 can also include a memory management service 218 configured to receive command(s) from the message broker 130. The memory management service 218 can be configured to select one or more zones relevant to a particular mission for an autonomous vehicle (e.g., the autonomous vehicle 103 of FIG. 1) for the purposes of validation and/or determination. For example, the memory management service 218 can be configured to select one or more zones that are relevant to a route determination. Rather than analyze the entirety of a set of map data, for example, the memory management service 218 can be configured to select the portion of the map data relevant to a proposed route.

In some implementations, the memory management service 218 can also be configured to communicate data to a shared memory 222. The shared memory 222 can include data sets relevant to validation and/or determination of a portion of a proposed mission for a vehicle (e.g., the autonomous vehicle 103 of FIG. 1). For example, the shared memory 222 can include pre-mission data 224, terrain data 226, zone data 228, route data 230, other data appropriate for validation and/or determination of the portion of the proposed mission, or a combination thereof. The pre-mission data 224 can include data associated with a planned route for a mission, waypoints for the mission, mission objectives, etc. The terrain data 226 can include data associated with terrain in an area relevant to the planned route, the planned mission, etc. The zone data 228 can include data associated with one or more geographic zones relevant to the planned route, the planned mission, etc. The route data 230 can include data associated with one or more waypoints along a proposed route, one or more entrance and/or exit points for a proposed route, emergency route deviation information, etc. In some aspects, the data stored at the shared memory 222 can correspond to one or more validation criteria of the plurality of validation criteria 126 of FIG. 1.

In some aspects, the shared memory 222 can also access external data sources. For example, the shared memory 222 can access an external data source including pre-mission plan data 232. The pre-mission plan data 232 can include data associated with a planned mission. The pre-mission plan data 232 can include data relevant to the various data sources described above with reference to the shared memory 222. For example, the pre-mission plan data 232 can include wind data, route data, zone data, digital terrain elevation data (DTED), etc.

In some implementations, the computing device 208 can also include the data logger 150 coupled to the message broker 130. As described above with reference to FIG. 1, the data logger 150 can include one or more components configured to record a plurality of validation determinations made by the one or more processors 106 during a mission associated with the autonomous vehicle 103. The data logger can be coupled to the validation services of the computing device 208 (e.g., the HSA validator 212, the route validator 214, the fuel validator 216, the memory management service 218, etc.). In a particular configuration, the data logger 150 can be coupled to the same data bus as the message broker 130.

In a particular aspect, the pre-mission plan data 232 can also include model data that can be used by the computing device 208 to model the command validation. For example, the model data can include performance data such as fuel burn that can inform the validation criteria 126 of FIG. 1. As a particular example, the model data can include data indicative of how quickly a particular model of autonomous vehicle uses fuel given certain operational constraints (e.g., speed, altitude, maneuvering, etc.).

In some implementations, the example architecture 200 can also include a vehicle adapter 147. The vehicle adapter 147 can include one or more components configured to communicate with the vehicle management system 110. As described in more detail above with reference to FIG. 1, the vehicle management system 110 can be configured to receive commands and execute those commands at a vehicle (e.g., the autonomous vehicle 103 of FIG. 1). The vehicle adapter 147 can be configured to translate data (e.g., the vehicle control command data 122 and/or the command compliance failure data 124 of FIG. 1) associated with the commands from one format to another. For example, the vehicle adapter 147 can be configured to translate data from a format understandable by the computing device 102 to a format understandable by the vehicle management system.

Although certain components of the architecture 200 are illustrated in FIG. 2, more, fewer, and/or different components can be present in a particular implementation without departing from the scope of the subject disclosure. For example, the computing device 208 can also include a stores management system validator. The stores management system validator can be, for example, coupled to the one or more processors 106 of FIG. 1. In the architecture 200, the stores management system validator can be coupled between the message broker 130 and the validator services and vehicle adapter 147. The message broker 130 can be configured to route messages to the stores management system validator, which can be configured to validate the incoming messages according to stores management system data before distributing the validated messages to the validators services and/or the vehicle adapter 147. The stores management system data is described in more detail above with reference to FIG. 1.

The example architecture 200 described above enables increased safety and/or efficient operation of an autonomous vehicle by validating the command(s) according to the plurality of validation criteria. For example, the computing device 208 can be configured to validate commands from the mission system(s) 202, the mission autonomy system(s) 204, or both according to data stored at the shared memory 222, as analyzed by one or more of the HSA validator 212, the route validator 214, or the fuel validator 216.

The example architecture 200 also enables the implementation of third-party autonomous flight control systems alongside a vehicle management system for an autonomous vehicle. By isolating command communication to and from the vehicle management system 110 and validating the command(s) prior to that communication, the example architecture 200 can present the vehicle management system 110 in a manner that is agnostic as to the particular automation system (e.g., the mission system(s) 202, the mission autonomy system(s) 204, or both) originating those command(s).

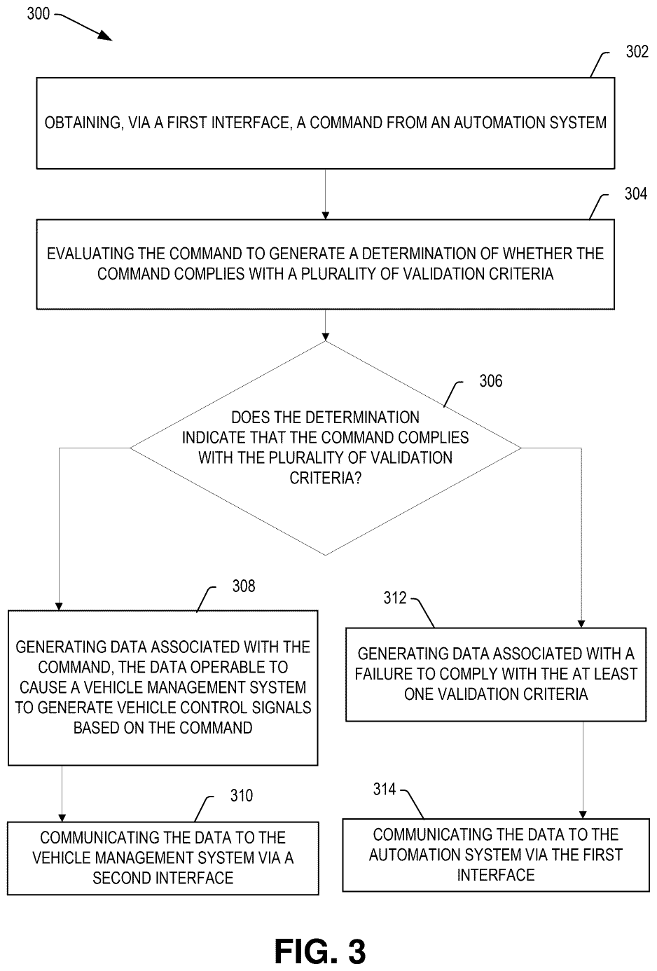

FIG. 3 is a flowchart that illustrates an example of a method 300 for validating real-time control of autonomous vehicles, in accordance with some examples of the subject disclosure. The method 300 can be initiated, performed, or controlled by one or more processors executing instructions, or by circuitry configured to cause performance of one or more operations, such as the processor(s) 106 of FIG. 1, the computing device 102 of FIG. 1, the computing device 208 of FIG. 2, or a combination thereof.

In some implementations, the method 300 includes, at block 302, obtaining, via a first interface, a command from an automation system. For example, the processor(s) 106 of FIG. 1 can be configured to obtain, via the first interface 144, the command(s) 148 from the automation system 104. The method 300 also includes, at block 304, evaluating the command to generate a determination of whether the command complies with a plurality of validation criteria. For example, the processor(s) 106 of FIG. 1 can be configured to evaluate the command(s) 148 to generate the command compliance determination 118, which includes data indicating whether the command(s) 148 comply with the plurality of validation criteria 126.

The method 300 also includes, at block 306, determining whether the determination indicates that the command complies with the plurality of validation criteria. For example, the processor(s) 106 can determine whether the command compliance determination 118 indicates that the command(s) 148 comply with the plurality of validation criteria 126.

When the determination indicates that the command complies with the plurality of validation criteria, the method 300 also includes, at block 308, generating data associated with the command, the data operable to cause the vehicle management system to generate vehicle control signals based on the command. For example, when the command compliance determination 118 of FIG. 1 indicates that the command(s) 148 comply with the plurality of validation criteria 126, the processor(s) 106 can be configured to generate the vehicle control command data 122, which includes data operable to cause the vehicle management system 110 to generate vehicle control signals (e.g., to control the autonomous vehicle 103) based on the command(s) 148. The method 300 also includes, at block 310, communicating the data to the vehicle management system via a second interface. For example, the processor(s) 106 of FIG. 1 can be configured to communicate the vehicle control command data 122 to the vehicle management system 110 via the second interface 146.

When the determination indicates that the command does not comply with at least one validation criteria of the plurality of validation criteria, the method 300 also includes, at block 312, generating data associated with a failure to comply with the at least one validation criteria. For example, when the command compliance determination 118 of FIG. 1 indicates that the command(s) 148 fail to comply with at least one of the plurality of validation criteria 126, the processor(s) 106 can be configured to generate the command compliance failure data, which includes data indicating a failure to comply with at least one of the plurality of validation criteria 126. The method 300 also includes, at block 314, communicating the data to the automation system via the first interface. For example, the processor(s) 106 of FIG. 1 can also be configured to communicate the command compliance failure data 124 to the automation system 104 via the first interface 144.

In some implementations, the method 300 can include more, fewer, and/or different steps without departing from the scope of the subject disclosure. For example, the method 300 can also include converting a message from the automation system in a first format to a second format, converting the message from the second format to a third format for the vehicle management system, selecting a plurality of validation criteria from among the plurality of validation criteria, determining a route for the vehicle, determining a heading for the vehicle, determining a collision avoidance for the vehicle, or a combination thereof.

The methods described above with reference to FIG. 3 can be implemented to realize one or more of the technical advantages described in more detail above. For example, the method 300 can enable the safe and/or efficient operation of an autonomous vehicle by validating the command(s) according to a plurality of validation criteria.

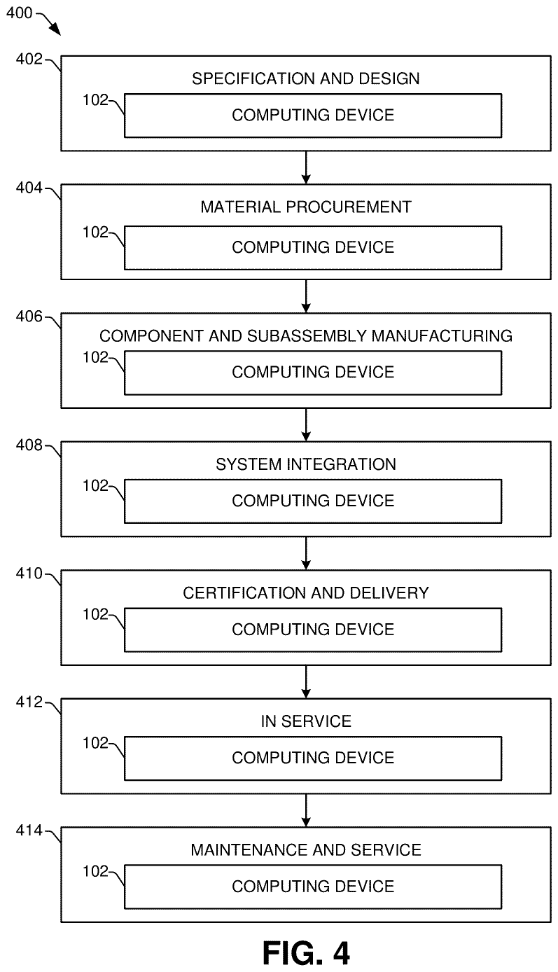

Referring to FIG. 4, a flowchart illustrative of an example of a life cycle of an aircraft that includes the computing device 102 is shown and designated 400. The computing device 102 can enable validating real-time control of autonomous vehicles. During pre-production, the exemplary method 400 includes, at 402, specification and design of an aircraft, such as the autonomous vehicle 103 of FIG. 1. During specification and design of the aircraft, the method 400 can include specification and design of the computing device that is configured to validate real-time control of autonomous vehicles. At 404, the method 400 includes material procurement, which can include procuring materials for the computing device.

During production, the method 400 includes, at 406, component and subassembly manufacturing and, at 408, system integration of the aircraft. For example, the method 400 can include component and subassembly manufacturing of the computing device 102 and system integration of the computing device 102. At 410, the method 400 includes certification and delivery of the aircraft and, at 412, placing the aircraft in service. Certification and delivery can include certification of the computing device 102 to place the computing device 102 in service. While in service by a customer, the aircraft can be scheduled for routine maintenance and service (which can also include the resource-efficient retrofit, modification, reconfiguration, refurbishment, and so on). At 414, the method 400 includes performing maintenance and service on the aircraft, which can include performing maintenance and service on the computing device 102.

Each of the processes of the method 400 can be performed or carried out by a system integrator, a third party, and/or an operator (e.g., a customer). For the purposes of this description, a system integrator can include without limitation any number of aircraft manufacturers and major-system subcontractors; a third party can include without limitation any number of venders, subcontractors, and suppliers; and an operator can be an airline, leasing company, military entity, service organization, and so on.

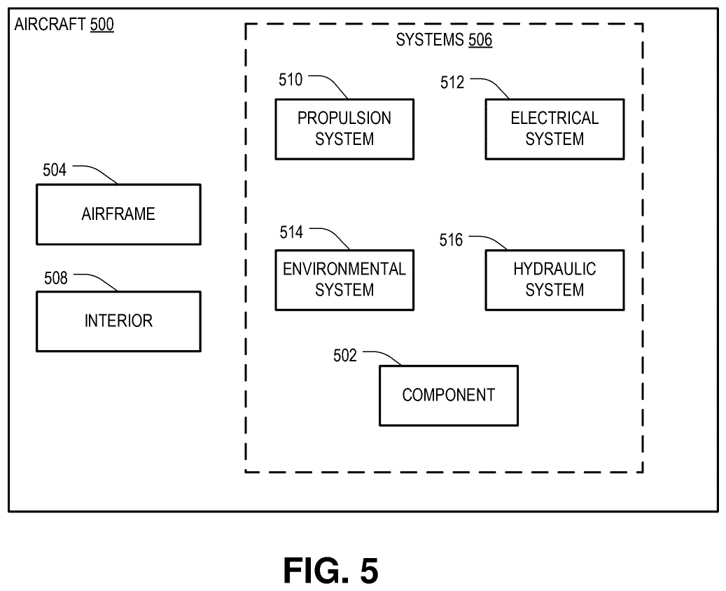

Aspects of the disclosure can be described in the context of an example of a vehicle. A particular example of a vehicle is an aircraft 500 as shown in FIG. 5. In the example of FIG. 5, the aircraft 500 includes an airframe 504 with a plurality of systems 506 and an interior 508. Examples of the plurality of systems 506 include one or more of a propulsion system 510, an electrical system 512, an environmental system 514, a hydraulic system 516, and a component 502. Any number of other systems can be included. In the example of FIG. 5, the component 502 includes a computing device configured to validate real-time control of autonomous vehicles, such as the computing device 102 of FIG. 1, the computing device 208 of FIG. 2, the computing device included in the vehicle associated with the method 300 of FIG. 3, the computing device included in the aircraft associated with the method 400 of FIG. 4, or any combination thereof.

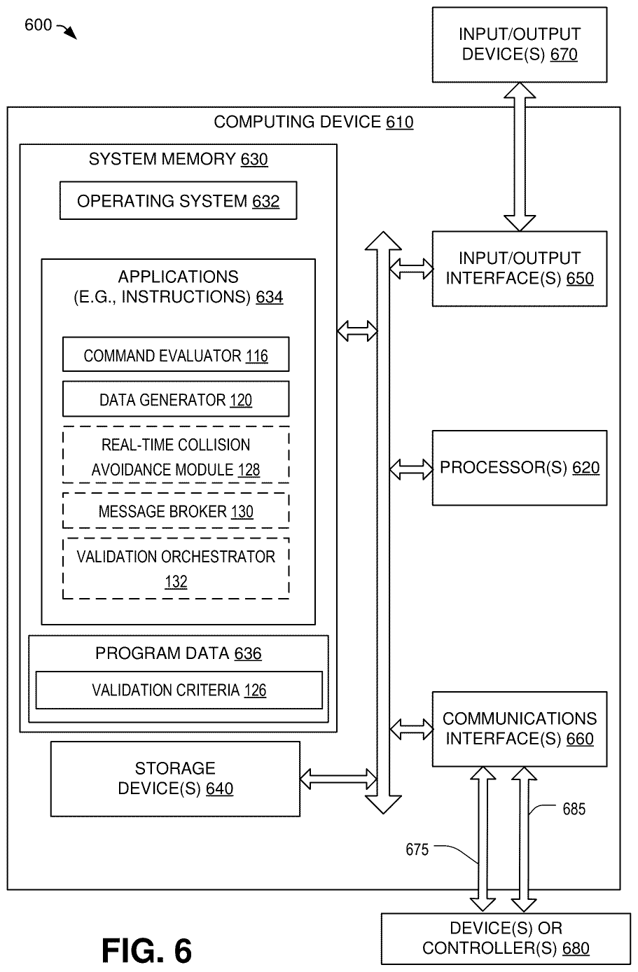

FIG. 6 is a block diagram of a computing environment 600 including a computing device 610 configured to support aspects of computer-implemented methods and computer-executable program instructions (or code) according to the present disclosure. For example, the computing device 610, or portions thereof, is configured to execute instructions to initiate, perform, or control one or more operations described with reference to FIGS. 1-5.

The computing device 610 includes one or more processors 620. The processor(s) 620 are configured to communicate with system memory 630, one or more storage devices 640, one or more input/output interfaces 650, one or more communications interfaces 660, or any combination thereof. The system memory 630 includes volatile memory devices (e.g., random access memory (RAM) devices), nonvolatile memory devices (e.g., read-only memory (ROM) devices, programmable read-only memory, and flash memory), or both. The system memory 630 stores an operating system 632, which can include a basic input/output system for booting the computing device 610 as well as a full operating system to enable the computing device 610 to interact with users, other programs, and other devices.

The system memory 630 stores system (program) data 636, such as the validation criteria 126 of FIG. 1. The system memory 630 includes one or more applications 634 (e.g., sets of instructions) executable by the processor(s) 620. As an example, the one or more applications 634 include instructions executable by the processor(s) 620 to initiate, control, or perform one or more operations described with reference to FIGS. 1-5. To illustrate, the one or more applications 634 include instructions executable by the processor(s) 620 to initiate, control, or perform one or more operations described with reference to the computing device 102 of FIG. 1, the computing device 208 of FIG. 2, or a combination thereof. The applications 634 can include, for example, the command evaluator 116 of FIG. 1, the data generator 120, the real-time collision avoidance module 128, the message broker 130, the validation orchestrator 132, or a combination thereof.

In a particular implementation, the system memory 630 includes a non-transitory, computer readable medium storing the instructions that, when executed by the processor(s) 620, cause the processor(s) 620 to initiate, perform, or control operations to enable validating real-time control of autonomous vehicles. The operations include obtaining, via a first interface, a command from the automation system. The operations also include evaluating the command to generate a determination of whether the command complies with a plurality of validation criteria. The operations also include, when the determination indicates that the command complies with the plurality of validation criteria, generating data associated with the command, the data operable to cause the vehicle management system to generate vehicle control signals based on the command; and communicating the data to the vehicle management system via the second interface. The operations also include, when the determination indicates that the command does not comply with at least one validation criteria of the plurality of validation criteria, generating data associated with a failure to comply with the at least one validation criteria; and communicating the data to the automation system via the first interface.

The one or more storage devices 640 include nonvolatile storage devices, such as magnetic disks, optical disks, or flash memory devices. In a particular example, the storage devices 640 include both removable and non-removable memory devices. The storage devices 640 are configured to store an operating system, images of operating systems, applications (e.g., one or more of the applications 634), and program data (e.g., the system program data 636). In a particular aspect, the system memory 630, the storage devices 640, or both, include tangible computer-readable media. In a particular aspect, one or more of the storage devices 640 are external to the computing device 610.

The one or more input/output interfaces 650 enable the computing device 610 to communicate with one or more input/output devices 670 to facilitate user interaction. For example, the one or more input/output interfaces 650 can include a display interface, an input interface, or both. For example, the input/output interface 650 is adapted to receive input from a user, to receive input from another computing device, or a combination thereof. In some implementations, the input/output interface 650 conforms to one or more standard interface protocols, including serial interfaces (e.g., universal serial bus (USB) interfaces, ethernet, military standard 1553, or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 670 includes one or more user interface devices and displays, including some combination of buttons, keyboards, pointing devices, displays, speakers, microphones, touch screens, and other devices.

The processor(s) 620 are configured to communicate with devices or controllers 680 via the one or more communications interfaces 660. For example, the one or more communications interfaces 660 can include a network interface. The devices or controllers 680 can include, for example, the autonomous vehicle 103 of FIG. 1, the automation system 104, the vehicle management system 110, the automation adapter 145 of FIG. 2, the mission system(s) 202, the mission autonomy system(s) 204, or a combination thereof. In some implementations, the processor(s) 620 are configured to communicate with the devices or controllers 680 via a low-assurance data bus 675 and a high-assurance data bus 685 isolated from the low-assurance data bus 675. As described in more detail above with reference to FIGS. 1-5, the computing device 610 can be configured to receive unverified commands via the low-assurance data bus 675 and communicate verified commands via the high-assurance data bus 685.

In conjunction with the described systems and methods, an apparatus is disclosed that includes means for obtaining, via a first interface, a command from the automation system. In some implementations, the means for obtaining includes the computing device 102 of FIG. 1, the processor(s) 106, the first interface 144, the command evaluator 116, the message broker 130, the computing device 208 of FIG. 2, the automation adapter 145, the message broker 130, one or more other circuits or devices configured to obtain the command, or a combination thereof.

The apparatus also includes means for evaluating the command to generate a determination of whether the command complies with a plurality of validation criteria. For example, the means for evaluating includes the computing device 102 of FIG. 1, the processor(s) 106, the command evaluator 116, the computing device 208 of FIG. 2, the HSA validator 212, the route validator 214, the fuel validator 216, the memory management service 218, the vehicle adapter 147, one or more other circuits or devices configured to generate the determination, or a combination thereof.

The apparatus also includes means for, when the determination indicates that the command complies with the plurality of validation criteria, generating data associated with the command, the data operable to cause the vehicle management system to generate vehicle control signals based on the command. For example, the means for generating the data includes the computing device 102 of FIG. 1, the processor(s) 106, the data generator 120, the computing device 208 of FIG. 2, the HSA validator 212, the route validator 214, the fuel validator 216, the memory management service 218, the vehicle adapter 147, one or more other circuits or devices configured to generate the data, or a combination thereof.

The apparatus also includes means for, when the determination indicates that the command complies with the plurality of validation criteria, communicating the data to the vehicle management system via the second interface. For example, the means for communicating the data includes the computing device 102 of FIG. 1, the processor(s) 106, the data generator 120, the second interface 146, the computing device 208 of FIG. 2, the HSA validator 212, the route validator 214, the fuel validator 216, the memory management service 218, the vehicle adapter 147, one or more other circuits or devices configured to communicate the data, or a combination thereof.

The apparatus also includes means for, when the determination indicates that the command does not comply with at least one validation criteria of the plurality of validation criteria, generating data associated with a failure to comply with the at least one validation criteria. For example, the means for generating the data includes the computing device 102 of FIG. 1, the processor(s) 106, the data generator 120, the computing device 208 of FIG. 2, the HSA validator 212, the route validator 214, the fuel validator 216, the memory management service 218, the vehicle adapter 147, one or more other circuits or devices configured to generate the data, or a combination thereof.

The apparatus also includes means for, when the determination indicates that the command does not comply with at least one validation criteria of the plurality of validation criteria, communicating the data to the automation system via the first interface. For example, the means for communicating the data includes the computing device 102 of FIG. 1, the processor(s) 106, the data generator 120, the first interface 144, the computing device 208 of FIG. 2, the HSA validator 212, the route validator 214, the fuel validator 216, the memory management service 218, the vehicle adapter 147, one or more other circuits or devices configured to communicate the data, or a combination thereof.

In some implementations, a non-transitory, computer readable medium stores instructions that, when executed by one or more processors, cause the one or more processors to initiate, perform, or control operations to perform part or all of the functionality described above. For example, the instructions can be executable to implement one or more of the operations or methods of FIGS. 1-6. In some implementations, part or all of one or more of the operations or methods of FIGS. 1-6 can be implemented by one or more processors (e.g., one or more central processing units (CPUs), one or more graphics processing units (GPUs), one or more digital signal processors (DSPs)) executing instructions, by dedicated hardware circuitry, or any combination thereof.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

Further, the disclosure comprises embodiments according to the following examples:

According to Example 1, a device includes a first interface configured to couple to an automation system of a vehicle, a second interface configured to couple to a vehicle management system of the vehicle, and one or more processors. The one or more processors are configured to obtain, via the first interface, a command from the automation system. The one or more processors are also configured to evaluate the command to generate a determination of whether the command complies with a plurality of validation criteria. The one or more processors are also configured to, when the determination indicates that the command complies with the plurality of validation criteria, generate data associated with the command, the data operable to cause the vehicle management system to generate vehicle control signals based on the command; and communicate the data to the vehicle management system via the second interface. The one or more processors are also configured to, when the determination indicates that the command does not comply with at least one validation criteria of the plurality of validation criteria, generate data associated with a failure to comply with the at least one validation criteria; and communicate the data to the automation system via the first interface.

Example 2 includes the device of Example 1, wherein the plurality of validation criteria comprises one or more vehicle route validation criteria, one or more vehicle fuel validation criteria, one or more heading validation criteria, one or more speed validation criteria, one or more altitude validation criteria, or a combination thereof.

Example 3 includes the device of Example 1 or Example 2, wherein the automation system comprises a remote operation control system.

Example 4 includes the device of any of Examples 1 to 3, wherein the automation system comprises an autonomous flight command system.

Example 5 includes the device of any of Examples 1 to 4, wherein the vehicle comprises an aircraft.

Example 6 includes the device of any of Examples 1 to 5 and further includes a real-time collision avoidance module coupled to the one or more processors.

Example 7 includes the device of any of Examples 1 to 6 and further includes an automation adapter configured to convert a message from the automation system in a first format to a second format.

Example 8 includes the device of any of Examples 1 to 7 and further includes a vehicle adapter configured to convert a message for the vehicle management system from the second format to a third format.

Example 9 includes the device of any of Examples 1 to 8 and further includes a validation orchestrator configured to select a first validation criterion and a second validation criterion from among the plurality of validation criteria.

Example 10 includes the device of Example 9, wherein the validation orchestrator is configured to select the first and second validation criteria based at least on a route determination for the vehicle.

Example 11 includes the device of Example 10, wherein the route determination is based at least on one or more of a no-fly zone determination, a route terrain determination, a route obstacle determination, or a collision avoidance determination.

Example 12 includes the device of any of Examples 9 to 11, wherein the validation orchestrator is configured to select the first and second validation criteria based at least on a collision avoidance determination for the vehicle.

Example 13 includes the device of Example 12, wherein the collision avoidance determination is based at least on Automatic Dependent Surveillance-Broadcast (ADSB) data.

Example 14 includes the device of any of Examples 9 to 13, wherein the validation orchestrator is configured to select the first and second validation criteria based at least on a heading determination for the vehicle.

Example 15 includes the device of Example 14, wherein the heading determination is based at least on one or more of a heading terrain determination, a heading obstacle determination, or a collision avoidance determination.

Example 16 includes the device of any of Examples 1 to 15 and further includes a data logger coupled to the one or more processors, the data logger configured to record a plurality of validation determinations made by the one or more processors during a mission associated with the vehicle.

According to Example 17, a method includes obtaining, via a first interface of a device, a command from an automation system. The method also includes evaluating the command to generate a determination of whether the command complies with a plurality of validation criteria. The method also includes, when the determination indicates that the command complies with the plurality of validation criteria, generating data associated with the command, the data operable to cause a vehicle management system to generate vehicle control signals based on the command; and communicating the data to the vehicle management system via a second interface of the device. The method also includes, when the determination indicates that the command does not comply with at least one validation criteria of the plurality of validation criteria, generating data associated with a failure to comply with the at least one validation criteria; and communicating the data to the automation system via the first interface.

Example 18 includes the method of Example 17, wherein the plurality of validation criteria comprises one or more vehicle route validation criteria, one or more vehicle fuel validation criteria, one or more heading validation criteria, one or more speed validation criteria, one or more altitude validation criteria, or a combination thereof.

Example 19 includes the method of Example 17 or Example 18, wherein the automation system comprises a remote operation control system.

Example 20 includes the method of any of Examples 17 to 19, wherein the automation system comprises an autonomous flight command system.

Example 21 includes the method of any of Examples 17 to 20, wherein the vehicle comprises an aircraft.

Example 22 includes the method of any of Examples 17 to 21 and further includes converting, by an automation adapter of the device, a message from the automation system in a first format to a second format.

Example 23 includes the method of any of Examples 17 to 22 and further includes converting, by a vehicle adapter of the device, a message for the vehicle management system from the second format to a third format.

Example 24 includes the method of any of Examples 17 to 23 and further includes selecting, by a validation orchestrator of the device, a first validation criterion and a second validation criterion from among the plurality of validation criteria.

Example 25 includes the method of Example 24 and further includes selecting, by the validation orchestrator, the first and second validation criteria based at least on a route determination for the vehicle.

Example 26 includes the method of Example 25, wherein the route determination is based at least on one or more of a no-fly zone determination, a route terrain determination, a route obstacle determination, or a collision avoidance determination.

Example 27 includes the method of Example 25 or Example 26 and further includes selecting, by the validation orchestrator, the first and second validation criteria based at least on a collision avoidance determination for the vehicle.

Example 28 includes the method of Example 27, wherein the collision avoidance determination is based at least on Automatic Dependent Surveillance-Broadcast (ADSB) data.

Example 29 includes the method of any of Examples 24 to 28 and further includes selecting, by the validation orchestrator, the first and second validation criteria based at least on a heading determination for the vehicle.

Example 30 includes the method of Example 29, wherein the heading determination is based at least on one or more of a heading terrain determination, a heading obstacle determination, or a collision avoidance determination.

Example 31 includes the method of any of Examples 17 to 30 and further includes recording, by a data logger of the device, a plurality of validation determinations during a mission associated with the vehicle.

According to Example 32, a non-transitory computer-readable medium comprises instructions that, when executed by one or more processors, cause the one or more processors to obtain, via a first interface of a device, a command from an automation system. The instructions, when executed by the one or more processors, also cause the one or more processors to evaluate the command to generate a determination of whether the command complies with a plurality of validation criteria. The instructions, when executed by the one or more processors, also cause the one or more processors to, when the determination indicates that the command complies with the plurality of validation criteria, generate data associated with the command, the data operable to cause a vehicle management system to generate vehicle control signals based on the command; and communicate the data to the vehicle management system via a second interface of the device. The instructions, when executed by the one or more processors, also cause the one or more processors to, when the determination indicates that the command does not comply with at least one validation criteria of the plurality of validation criteria, generate data associated with a failure to comply with the at least one validation criteria; and communicate the data to the automation system via the first interface.

Example 33 includes the non-transitory computer-readable medium of Example 32, wherein the plurality of validation criteria comprises one or more vehicle route validation criteria, one or more vehicle fuel validation criteria, one or more heading validation criteria, one or more speed validation criteria, one or more altitude validation criteria, or a combination thereof.

Example 34 includes the non-transitory computer-readable medium of Example 32 or Example 33, wherein the automation system comprises a remote operation control system.

Example 35 includes the non-transitory computer-readable medium of any of Examples 32 to 34, wherein the automation system comprises an autonomous flight command system.

Example 36 includes the non-transitory computer-readable medium of any of Examples 32 to 35, wherein the vehicle comprises an aircraft.

Example 37 includes the non-transitory computer-readable medium of any of Examples 32 to 36, wherein the instructions, when executed by the one or more processors, further cause the one or more processors to convert a message from the automation system in a first format to a second format.

Example 38 includes the non-transitory computer-readable medium of any of Examples 32 to 37, wherein the instructions, when executed by the one or more processors, further cause the one or more processors to convert a message for the vehicle management system from the second format to a third format.

Example 39 includes the non-transitory computer-readable medium of any of Examples 32 to 38, wherein the instructions, when executed by the one or more processors, further cause the one or more processors to select a first validation criterion and a second validation criterion from among the plurality of validation criteria.

Example 40 includes the non-transitory computer-readable medium of Example 39, wherein the instructions, when executed by the one or more processors, further cause the one or more processors to select the first and second validation criteria based at least on a route determination for the vehicle.

Example 41 includes the non-transitory computer-readable medium of Example 40, wherein the route determination is based at least on one or more of a no-fly zone determination, a route terrain determination, a route obstacle determination, or a collision avoidance determination.

Example 42 includes the non-transitory computer-readable medium of any of Examples 39 to 41, wherein the instructions, when executed by the one or more processors, further cause the one or more processors to select the first and second validation criteria based at least on a collision avoidance determination for the vehicle.

Example 43 includes the non-transitory computer-readable medium of Example 42, wherein the collision avoidance determination is based at least on Automatic Dependent Surveillance-Broadcast (ADSB) data.

Example 44 includes the non-transitory computer-readable medium of any of Examples 39 to 43, wherein the instructions, when executed by the one or more processors, further cause the one or more processors to select the first and second validation criteria based at least on a heading determination for the vehicle.

Example 45 includes the non-transitory computer-readable medium of Example 44, wherein the heading determination is based at least on one or more of a heading terrain determination, a heading obstacle determination, or a collision avoidance determination.

Example 46 includes the non-transitory computer-readable medium of any of Examples 32 to 45, wherein the instructions, when executed by the one or more processors, further cause the one or more processors to record a plurality of validation determinations during a mission associated with the vehicle.

According to Example 47, an autonomous vehicle includes an automation system, a vehicle management system, and a device. The device includes a first interface configured to couple to the automation system, a second interface configured to couple to the vehicle management system, and one or more processors. The one or more processors are configured to obtain, via the first interface, a command from the automation system. The one or more processors are also configured to evaluate the command to generate a determination of whether the command complies with a plurality of validation criteria. The one or more processors are also configured to, when the determination indicates that the command complies with the plurality of validation criteria, generate data associated with the command, the data operable to cause the vehicle management system to generate vehicle control signals based on the command; and communicate the data to the vehicle management system via the second interface. The one or more processors are also configured to, when the determination indicates that the command does not comply with at least one validation criteria of the plurality of validation criteria, generate data associated with a failure to comply with the at least one validation criteria; and communicate the data to the automation system via the first interface.

Example 48 includes the autonomous vehicle of Example 47, wherein the plurality of validation criteria comprises one or more vehicle route validation criteria, one or more vehicle fuel validation criteria, one or more heading validation criteria, one or more speed validation criteria, one or more altitude validation criteria, or a combination thereof.

Example 49 includes the autonomous vehicle of Example 47 or Example 48, wherein the automation system comprises a remote operation control system.

Example 50 includes the autonomous vehicle of any of Examples 47 to 49, wherein the automation system comprises an autonomous flight command system.

Example 51 includes the autonomous vehicle of any of Examples 47 to 50, wherein the vehicle comprises an vehicle.

Example 52 includes the autonomous vehicle of any of Examples 47 to 51 and further includes a real-time collision avoidance module coupled to the one or more processors.

Example 53 includes the autonomous vehicle of any of Examples 47 to 52 and further includes an automation adapter configured to convert a message from the automation system in a first format to a second format.

Example 54 includes the autonomous vehicle of any of Examples 47 to 53, and further includes a vehicle adapter configured to convert the message from the second format to a third format for the vehicle management system.

Example 55 includes the autonomous vehicle of any of Examples 47 to 54 and further includes a validation orchestrator configured to select a first validation criterion and a second validation criterion from among the plurality of validation criteria.

Example 56 includes the autonomous vehicle of Example 55, wherein the validation orchestrator is configured to select the first and second validation criteria based at least on a route determination for the vehicle.

Example 57 includes the autonomous vehicle of Example 56, wherein the route determination is based at least on one or more of a no-fly zone determination, a route terrain determination, a route obstacle determination, or a collision avoidance determination.

Example 58 includes the autonomous vehicle of any of Examples 55 to 57, wherein the validation orchestrator is configured to select the first and second validation criteria based at least on a collision avoidance determination for the vehicle.

Example 59 includes the autonomous vehicle of Example 58, wherein the collision avoidance determination is based at least on Automatic Dependent Surveillance-Broadcast (ADSB) data.

Example 60 includes the autonomous vehicle of any of Examples 55 to 59, wherein the validation orchestrator is configured to select the first and second validation criteria based at least on a heading determination for the vehicle.

Example 61 includes the autonomous vehicle of Example 60, wherein the heading determination is based at least on one or more of a heading terrain determination, a heading obstacle determination, or a collision avoidance determination.

Example 62 includes the autonomous vehicle of any of Examples 47 to 61 and further includes a data logger coupled to the one or more processors, the data logger configured to record a plurality of validation determinations made by the one or more processors during a mission associated with the vehicle.

Example 63 includes the device of any of Examples 8 to 15, wherein the validation orchestrator is configured to select the first and second validation criteria based at least on a load management determination for the vehicle.

Example 64 includes the method of any of Examples 24 to 31, wherein selecting the first and second validation criteria is based at least on a load management determination for the vehicle.

Example 65 includes the non-transitory computer-readable medium of any of Examples 32 to 38, wherein the instructions, when executed by the one or more processors, further cause the one or more processors to select the first and second validation criteria based at least on a load management determination for the vehicle.

Example 66 includes the autonomous vehicle of any of Examples 55 to 62, wherein the validation orchestrator is configured to select the first and second validation criteria based at least on a load management determination for the vehicle.

Example 67 includes the device of any of Examples 1 to 15 or 63, and further includes a stores management system validator coupled to the one or more processors.

Example 68 includes the autonomous vehicle of any of Examples 47 to 62 or 66, and further includes a stores management system validator coupled to the one or more processors.

What is claimed is:

1. A device comprising:
a first interface configured to couple to an automation system of a vehicle;
a second interface configured to couple to a vehicle management system of the vehicle;
one or more processors configured to:
obtain, via the first interface, a command from the automation system;
evaluate the command to generate a determination of whether the command complies with a plurality of validation criteria; and
when the determination indicates that the command complies with the plurality of validation criteria:
generate data associated with the command, the data operable to cause the vehicle management system to generate vehicle control signals based on the command; and
communicate the data to the vehicle management system via the second interface; and
when the determination indicates that the command does not comply with at least one validation criteria of the plurality of validation criteria:
generate data associated with a failure to comply with the at least one validation criteria; and
communicate the data to the automation system via the first interface.

2. The device of claim 1, wherein the plurality of validation criteria comprises one or more vehicle route validation criteria, one or more vehicle fuel validation criteria, one or more heading validation criteria, one or more speed validation criteria, one or more altitude validation criteria, or a combination thereof.

3. The device of claim 1, wherein the automation system comprises a remote operation control system.

4. The device of claim 1, wherein the automation system comprises an autonomous flight command system.

5. The device of claim 1, further comprising a real-time collision avoidance module coupled to the one or more processors.

6. The device of claim 1, further comprising an automation adapter configured to convert a message from the automation system in a first format to a second format.

7. The device of claim 6, further comprising a vehicle adapter configured to convert the message from the second format to a third format for the vehicle management system.

8. The device of claim 1, further comprising a validation orchestrator configured to select a first validation criterion and a second validation criterion from among the plurality of validation criteria.

9. The device of claim 8, wherein the validation orchestrator is configured to select the first and second validation criteria based at least on a route determination for the vehicle.

10. The device of claim 9, wherein the route determination is based at least on one or more of a no-fly zone determination, a route terrain determination, a route obstacle determination, or a collision avoidance determination.

11. The device of claim 8, wherein the validation orchestrator is configured to select the first and second validation criteria based at least on a collision avoidance determination for the vehicle.

12. The device of claim 11, wherein the collision avoidance determination is based at least on Automatic Dependent Surveillance-Broadcast (ADSB) data.

13. The device of claim 8, wherein the validation orchestrator is configured to select the first and second validation criteria based at least on a load management determination for the vehicle.

14. The device of claim 8, wherein the validation orchestrator is configured to select the first and second validation criteria based at least on a heading determination for the vehicle.

15. The device of claim 13, wherein the heading determination is based at least on one or more of a heading terrain determination, a heading obstacle determination, or a collision avoidance determination.

16. The device of claim 1, further comprising a data logger coupled to the one or more processors, the data logger configured to record a plurality of validation determinations made by the one or more processors during a mission associated with the vehicle.

17. An autonomous vehicle comprising:
an automation system;
a vehicle management system; and
a device comprising:
a first interface configured to couple to the automation system;
a second interface configured to couple to the vehicle management system;
one or more processors configured to:
obtain, via the first interface, a command from the automation system;
evaluate the command to generate a determination of whether the command complies with a plurality of validation criteria ; and
when the determination indicates that the command complies with the plurality of validation criteria:
generate data associated with the command, the data operable to cause the vehicle management system to generate vehicle control signals based on the command; and
communicate the data to the vehicle management system via the second interface; and
when the determination indicates that the command does not comply with at least one validation criteria of the plurality of validation criteria:
generate data associated with a failure to comply with the at least one validation criteria; and
communicate the data to the automation system via the first interface.

18. The vehicle of claim 17, further comprising a real-time collision avoidance module coupled to the one or more processors.

19. The vehicle of claim 17, further comprising a stores management system validator coupled to the one or more processors.

20. A method comprising:
obtaining, via a first interface of a device, a command from an automation system;
evaluating the command to generate a determination of whether the command complies with a plurality of validation criteria; and
when the determination indicates that the command complies with the plurality of validation criteria:
generating data associated with the command, the data operable to cause a vehicle management system to generate vehicle control signals based on the command; and
communicating the data to the vehicle management system via a second interface of the device; and
when the determination indicates that the command does not comply with at least one validation criteria of the plurality of validation criteria:
generating data associated with a failure to comply with the at least one validation criteria; and
communicating the data to the automation system via the first interface.
